(19) United States
(12) Patent Application Publication
(10) Pub. No.: US 2013/0246156 A1
(43) Pub. Date: Sep. 19, 2013

(54) SYSTEMS AND METHODS INVOLVING PLAYBACK OF MEDIA FILES

(71) Applicants: Daniel Patrick Murphy, Coronado, CA (US); Rodney E. Underhill, Julian, CA (US)

(72) Inventors: Daniel Patrick Murphy, Coronado, CA (US); Rodney E. Underhill, Julian, CA (US)

(73) Assignee: EarDish Corporation

(21) Appl. No.: 13/419,263

(22) Filed: Mar. 13, 2012

(51) Int. Cl. G06Q 30/02

(52) U.S. Cl. 705/14.36

(57) ABSTRACT

Disclosed herein are methods and systems from encouraging complete playback of media files, such as music albums. Media files can be provided to a user for playback using a specific media player that can determine if the media files are played through in the entirety by the user, or if the user only listens to certain portions and/or fast-forwards through parts of the media file. User are encouraged to listed the entire media file, including advertisements included therein, by offering the users rewards for doing so. Whether or not a user gets a reward can also be contingent on what media file is played, what time the media file is play, who the user is, and/or other factors.

### FIELD

This disclosure is related to methods and systems involving playback of media files and, in particular, for encouraging complete playback of media files.

### BACKGROUND

Many music albums and other media works are designed to be listened to in their entirety, rather than one portion (e.g., one song) at a time. In the context of albums, for example, artists often create and arrange the individual tracks of an album such that they synergistically create an album listening experience that cannot be experienced by listening to individual tracks or by shuffling the tracks out of order. However, the recent popularity of purchasing and listening to individual tracks from an album, totally divorced from the rest of the album, or in a random order, has diminished the value of the album experience, much to the dismay of many artists. This is also true of other media formats such as movies, television shows, radio shows, etc. Accordingly, there is a need for methods and systems that encourage people to experience entire artistic creations from beginning to end, or at least particular sequences of media files.

### SUMMARY

In one embodiment, a method is provided for encouraging playback of certain media files. The method can include the steps of receiving registration information from a user, providing a media player to the user, providing a media file to the user (with the media file being configured to require the media player to be played), receiving an indication that the user played the entire media file using the media player, and determining that the user is eligible for a reward based on the indication that the user played the entire media file.

In some embodiments, the registration information comprises demographic information about the user and the reward is based at least in part on the demographic information. The media file can include at least one trigger portion configured to indicate to the media player that the media file has been played through the trigger portion. The media file can include at least one notification portion configured to notify the user of the reward. The media player can be configured to determine that the media file has been played entirely without user-caused interruption. In some embodiments, the method can include selecting one or more advertisements based on the registration information and inserting the selected advertisements into the media file prior to providing the media file to the user. The determination of eligibility can include determining that the media file was played by the user within a predetermined time range and/or determining that media file was played by the user in a predetermined location. The reward can include an entry into a contest and/or points that can be redeemed for a prize. In some embodiments, the media file can be a music album.

In another embodiment, the method can include receiving registration information from a user, providing a media player to the user, receiving a selection of a desired media file from a user, selecting at least one advertisement targeted to the user based on the registration information, inserting the advertisement into the media file, providing the media file to the user (with the media file being configured to require the media player for playback by the user), and determining, with the media player, that the media file has been played entirely by the user. The method can also include notifying the user of a reward for playing the media file entirely.

In some embodiments, the determining that the media file has been played entirely comprises determining that the media file has not be fast-forwarded and that the media filed has been played from a beginning to an end without interruption. In other embodiments, the media file comprises a trigger portion and determining that the media file has been played entirely comprises determining the trigger portion has been played without interruption. In some embodiments, notifying the user of a reward is contingent on a determination that the media file was played during a certain time range and/or on the user having a predetermined demographic attribute. In other embodiments, it can be determined whether the media file was played on the provided media player and the media player can be configured to track who the user is and the time when the media file is played.

In some embodiments, the media player can be configured to receive the selection of a desired media file from the user, select and insert the advertisements based on information about the user, and notify the user of the reward. The media file can comprises an audio album comprising plural audio tracks, and wherein determining that the media file has been played entirely comprises determining that each of the audio tracks has been played in sequential order without fast-forwarding.

The foregoing and other objects, features, and advantages of the invention will become more apparent from the following detailed description, which proceeds with reference to the accompanying figures.

### BRIEF DESCRIPTION OF THE DRAWINGS

FIG. 1 illustrates a timeline of an exemplary media file.

FIG. 2 illustrates an exemplary method for encouraging complete playback of media files.

FIG. 3 illustrates another exemplary method for encouraging complete playback of media files.

FIG. 4 is a schematic block diagram of an exemplary computing system on which certain embodiments of the systems and methods disclosed herein can be implemented.

FIG. 5 is a block diagram illustrating a computer network that can be used to perform at least some of the embodiments of the systems and methods disclosed herein.

FIG. 6 is a block diagram illustrating another computer network that can be used to perform at least some of the embodiments of the systems and methods disclosed herein.

FIG. 7 is a block diagram illustrating how the computer networks of FIG. 5 or 6 can be used to perform certain aspects of the systems and methods disclosed herein.

### DETAILED DESCRIPTION

### General Considerations

For purposes of this description, certain aspects, advantages, and novel features of the embodiments of this disclosure are described herein. The disclosed methods, apparatuses, and systems should not be construed as limiting in any way. Instead, the present disclosure is directed toward all novel and nonobvious features and aspects of the various disclosed embodiments, alone and in various combinations and sub-combinations with one another. The methods, apparatuses, and systems are not limited to any specific aspect or feature or combination thereof, nor do the disclosed embodiments require that any one or more specific advantages be present or problems be solved.

Although the operations of some of the disclosed methods are described in a particular, sequential order for convenient presentation, it should be understood that this manner of description encompasses rearrangement, unless a particular ordering is required by specific language. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “determine” and “provide” to describe the disclosed methods. These terms are high-level abstractions of the actual operations that are performed. The actual operations that correspond to these terms may vary depending on the particular implementation and are readily discernible by one of ordinary skill in the art.

As used herein, the terms “a”, “an” and “at least one” encompass one or more of the specified element. That is, if two of a particular element are present, one of these elements is also present and thus “an” element is present. The terms “a plurality of” and “plural” mean two or more of the specified element.

As used herein, the term “and/or” used between the last two of a list of elements means any one or more of the listed elements. For example, the phrase “A, B, and/or C” means “A,” “B,” “C,” “A and B,” “A and C,” “B and C” or “A, B and C.”

As used herein, the term “coupled” generally means mechanically, chemically, electrically, or otherwise coupled or linked and does not exclude the presence of intermediate elements between the coupled or associated items absent specific contrary language.

### Systems and Methods for Encouraging Complete Playback of Media Files

The systems and methods described herein can be implemented to encourage complete playback of media files. The term “media file” is used broadly and includes all forms of audio and video files, including music albums, radio shows, television shows, movies, and the like.

Many people listen to and/or watch media files that are streamed over or downloaded from a network, such as the Internet. Some media files are in the form of a podcast or webcast that is acquired from a network and enjoyed on a personal computing device, such as a smart phone or a personal computer. To play certain media files, it can sometimes be necessary to have a specific media player software (such as an “app”) installed on one's personal computing device, or to use a particular website to stream or download the media files. Such media player software and websites can be used to play the media files in a particular way, to insert advertisements, and/or to record certain information about the media files, the user, and/or the circumstances of the playback.

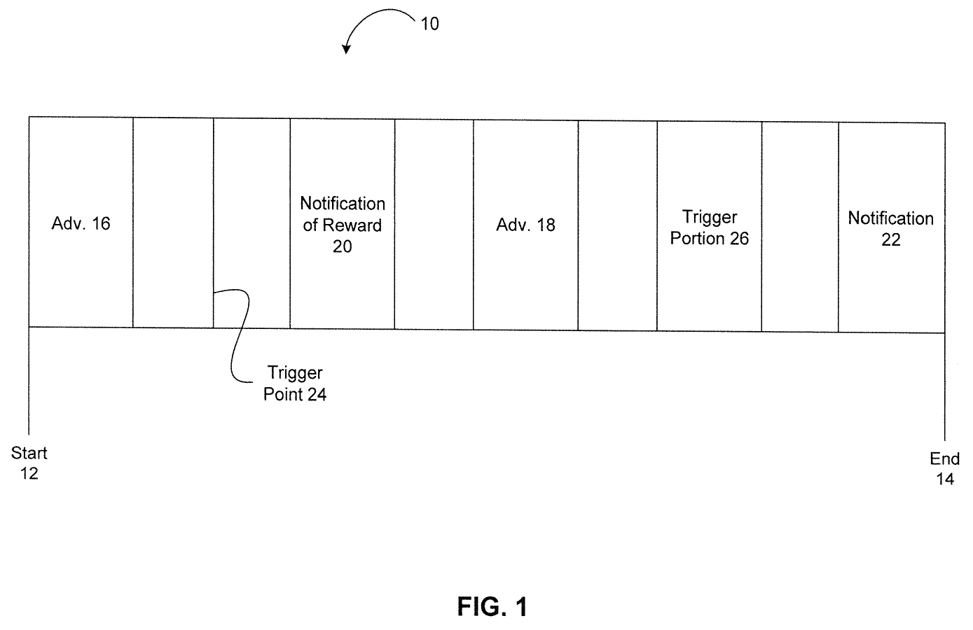

The media files can include advertisements. Media files can begin with an introductory advertisement and/or can include advertisements embedded at various intermediate portions of the media files. FIG. 1 shows a timeline of an exemplary media file 10 that comprises a start time 12 and an end time 14. The media file 10 comprises an introductory advertisement 16 at the start and an intermediate advertisement 18 later in the playback. The advertisements can be paid for by sponsors of the media files, such that the media files can be provided to end users at little or no monetary cost. However, advertisements are less effective when end users can skip past them or do not get to the portion of the media file where the advertisement is located. Thus, encouraging people to listen to and/or watch entire media files can help ensure that the end user is exposed to the advertisements embedded in the media file, no matter in which portion of the media file they are located.

Advertisements in the media files can be targeted based on demographics and other information of the end users. Information of end users can be determined based on information collected by media player software installed on the end users personal computing device on which a media file is played, or by the website used to stream the media file. In order to collect demographic information, end users can be required to register with the software or website, such as by providing person information like gender, age, location, etc. This demographic information can be collected and correlated to particular advertisements that are targeted at that type of end user. Additional information can be collected by the software and used in the determination of which advertisements to include in the media files, such as information about media files that have been played or downloaded on that device, purchasing history, user's IP address, operating system, browser, etc.

In one exemplary method, an end user orders a downloadable or streamable media file. Advertisements are then selected based on demographic information about the end user, buyer statistics, and/or other factors, and embedded into the media file. The media file is then provided to the end user for playback. The media file can also include features that only allow it to be played with a particular media player that can be downloaded from the provider of the media files. In some embodiments, the choice of advertisements and the insertion of the advertisements is performed by the native media player software on the end users personal computing device, while in other embodiments, these actions can be performed remotely.

The media player can, for example, be based on Winamp's open source code and modified so that the media player can track who the end user is, collect demographic information, and/or select and insert advertisements into media files based in the collected information.

To encourage complete playback of media files, various forms of rewards can be offered to the end user. In one example, the media player can determine if an entire media file has been played, and if so, it can present a reward to the end user. In another example, one or more notifications of a reward can be embedded at a random time slots in the media file such that the end user is encouraged to play through the whole media file to find the embedded rewards. In FIG. 1, the exemplary media file 10 comprises a first notification 20 of a reward near the start 12, and a second notification 22 of a reward near the end 14 of the media file.

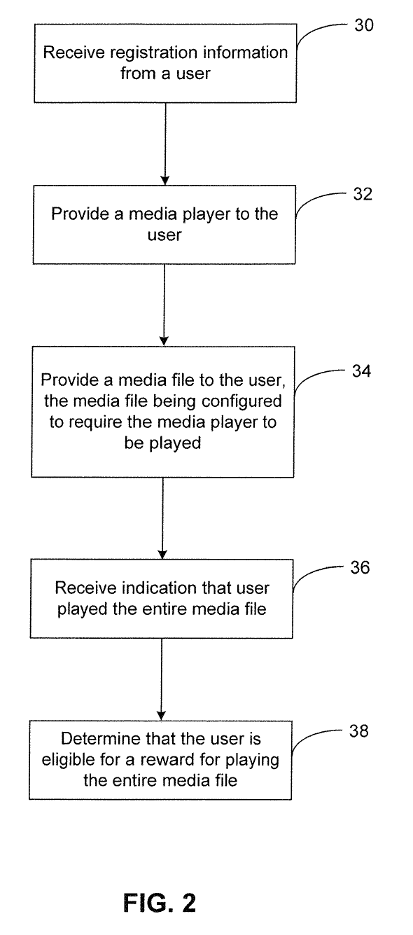

FIG. 2 is a flow chart illustrating an exemplary method for encouraging complete playback of media files. At 30, registration information is received from a user. The registration information can include demographic information and other information about the user. At 32, a media player can be provided to the user. In some embodiments, the media player can be provided to the user prior to registration. The media player can be provided from a server and/or database at a remote location. The media player can be an app native on the user's smart phone, for example, for playing media files and transmitting information with a remote server. At 34, a media file can be provided to the user that is configured to require the provided media player to be played. This can force users to use the provided media player software rather than some other generic media player. The provided media player can be configured to record information about the playback of the provided media file, such as when it was played, what user played it, and whether it was played back in its entirety or was interrupted by the user, such as by fast-forwarding. The media files can be stored at and provided from a server and/or a database at a remote location. At 36, an indication can be received, such as from the media player, that the user has played the entire media file. At 38, it can be determined that the user is eligible for a reward based on the indication that the user played the entire media file.

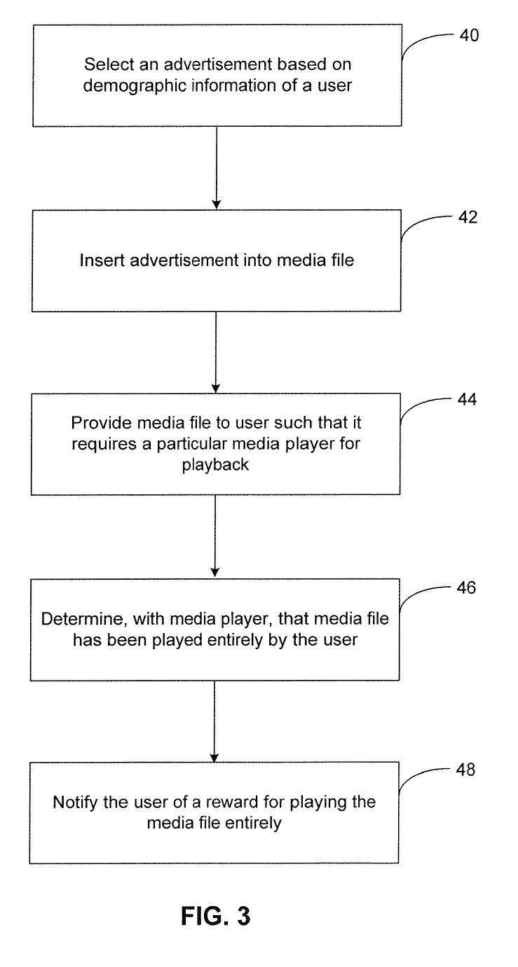

FIG. 3 is a flow chart illustrating another exemplary method that encourages complete playback of media files. At 40, at least one advertisement is selected based on demographic information about a user. This information can be provided by the user during registration. At 42, the advertisement is inserted or embedded into a media file that is chosen by the user. At 44, the media file with the advertisement is provided to the user for playback. The media file can be configured to require a custom media player to be played, which media player can also be provided to the user. At 46, the a determination can be made, using the media player, that the media file with the advertisement has been played entirely by the user, which can also indicate that the user can played the advertisement in the media file. At 48, the user can be notified of a reward for playing the media file completely, such as with notifications displayed with the media player and/or notifications send via email, text, etc. The promise of a reward can encourage the user to play the whole media file including the advertisement, which can be attractive to potential sponsors.

The rewards can include various concepts that entice end users to want them. One example of a reward is an entry into a contest, such as a lottery or sweepstakes. For example, of the user is reaches a certain point in the media file, the user can be automatically entered into a sweepstakes to win a prize. The automatic entry can be based in the user information provided to the media player during the initial registration. Another example of a reward is a code or password that is displayed or played to the user. Such a code or password can then be used by the user, for example, on a website to collect a prize or enter a contest. Another type or reward can be a points system where the user accumulates points each time they pass by specified points in a media file. The accumulated points can later be redeemed to collect prizes or enter contests. In one example, points can be redeemed to get advertisement-free versions of media files. Various other types of rewards can also be offered to entice users to playback media files in their entirety.

In some embodiments, the media player or website can determine if a user has fast-forwarded through any portion of the media file, skipped tracks, or otherwise interrupted start to finish playback of the media file, and can negate a reward in response.

Rewards for playing media files can be tracked in various ways. In some embodiments, a code or codes can be embedded in the media file. For example, if in an album, the code can be embedded in an advertisement included with the album. If in a movie, the code can be embedded in one or more of the advertisements, or in one of more of the non-advertisement scenes of the movie, so that the viewer cannot fast forward to the location of the code.

When the code is triggered during the play of the media file, the code can cause a report to issue to a server that records the information that the particular user has heard or seen that particular portion of the media file. Information sent to the server can include the user's registered information (e.g., name, age and other demographical information as described in other embodiments herein), as well as the user's IP, operating system, browser, etc.

The point or portion of a media file that triggers a reward can be located anywhere in the media file. There can be more than one such point or portion in a single media file. For example, there can be a “trigger point” in each track of an audio album. In the example shown in FIG. 1, the media file 10 comprises a trigger point 24 just before the first notification of a reward 20. Playing the media file across a trigger point can lead to a reward. The trigger can be a portion of the media file as opposed to a point in time, such a particular song or a few seconds or minutes of media content. For example, the media file 10 in FIG. 1 comprises a trigger portion 26 near the end 14. Playing this trigger portion of the file can lead to a reward for the user. The “trigger portion” can be any length of time and can be located anywhere in the media file.

The user may or may not be alerted that a trigger has been reached while they are enjoying the media file. For example, the media player can silently determine and record that the trigger has been played and not interrupt the playback of the media file so as to not diminish the experience of enjoying the media file. In other examples, the media file can display or alert the user that they have triggered a reward immediately when the trigger has been played, and/or at the end of the playback. In some examples, the entire length of a trigger portion of a media file must be played through to trigger a reward. In such a case, if the trigger portion is five minutes long, the user will have to play through the whole five minutes from start to finish without fast-forwarding or skipping in order to trigger the reward. A whole media file can be a trigger portion.

In some embodiments, a user is required to play through an entire media file more than once in order to get a reward, which encourages repeated playthroughs and can encourage a user to “get into” an album or other media file and habitually play the media file even after they get a reward.

In some embodiments, whether or not a user gets a reward can be dependent on what media file they are playing, when they play the media file, and/or who the user is. Some rewards can only be triggered by playing a particular media file. For example, a particular music album can be tied to a specific reward, which can only be won by a user by play that particular album. This can be used to promote particular albums and/or to tie certain reward to an album that are both somehow associated with each other. For example, listening to a first album from artist X can trigger a reward that gives the user a discount on a purchasing another album by artist X. As another example, watching a skateboarding video can trigger a reward that allows the user to enter a contest to win a new skateboard.

Whether or not a user gets a reward can also be dependent on when they play a media file. A particular reward may only be available if a user is listening to any media file on a certain day or at a certain time or time range during the day. For example, a user who happens to be playing a media file between 9 a.m. and 11 a.m. may get a particular reward (such as free passes to an event later that day) that is independent of which media file is being played and is not available during other times of the day. Such a “winning hour” can be kept secret from the user to encourage playback throughout the day, or can be announced to users to encourage playback during that particular time, such as during off-peak downloading/streaming times.

The demographics of the user can also determine whether or not they get a particular reward. For example, only female user might get a reward that is related to female-oriented products, or only users in a certain age range might get a reward targeted at that age of people. Rewards can be based on any number of demographic factors, such as age, gender, location, religion, race, finances, career, education, etc.

Some rewards can be offered to many different users, while other rewards can be limited in quantity or only available to a single user. The same rewards can be offered a plurality of different times, while some rewards can only be won once.

To collect a reward, users can be directed to particular websites, where users can be offered additional media files and/or exposed to advertisements. Some winners can get an email, text, and/or phone call indicating that they have won a reward and with instructions on how to get it. Some winners can be notified via the media player that they have won.

Users can also be alerted to upcoming contests via email, text, call, or the media player. They can receive a message indicating the circumstances of how to win an upcoming reward or contest. Such a message might notify users that playing any media file in its entirety via the particular media player next week makes them eligible to win certain rewards. Other messages might be specific to a location, such as reward X is only available to users listening to complete albums via the media player in the state of Ohio, or to user who reside in New York City. Some messages might say that listening through a particular new album from start to finish can get users entered into a contest to win tickets to that artist's upcoming concert. A message might indicate that there are secret codes embedded in a particular album and that users can only hear the code words by playing through the whole album on the particular media player and listening carefully for the code words embedded throughout the album.

The offering of rewards encourages users to acquire and play to more media files and to play through entire media files from start to finish, rather than playing only single tracks or skipping around within a media file. Knowing that their artistic creation is more likely to be play entirely from start to finish by end users can encourage artists to provide their media files to user via the disclosed systems and methods. For example, Artists who create music albums that are designed to be listed to from start to finish will have an incentive to distribute their albums via the disclosed systems and methods as opposed to iTunes™ where users can simply buy and download individual songs from the album and are less likely to acquire and listen to the entire album.

Offering rewards also increases the chance that users will listen to and/or watch advertisements embedded in the media files. This can increase the amount of money advertisers are willing to pay for the same advertisement, and increase revenue from the provider and the artists.

In some embodiments, the artists can also get rewards for providing their album to users via the disclosed systems and methods.

### Registration and Creation of User Information Database

In order to accomplish the methods disclosed herein, users can be required to register with the system, such as via the media player or a website. For example, the system can register a user by exchanging information between the user's computing device and a server.

A non-registered user can interact with the media play or website in order to view media content and potential rewards. If a non-registered user does not register with the system, the non-registered user cannot participate in the system further. In some embodiments, the non-registered user may be permitted to have limited participation with the system. However, in order to be able to acquire the desired demographic information and/or other user information, each user should register with the system and provide at least a small amount of personal information.

A user database can be created containing demographic profile information of the plurality of registered users, including demographic profile information for each registered user, to include each registered user's zip code, city, country, user name, user password, user email address, gender, age-bracket, and/or other information.

The plurality of registered users enable the system to attract advertisers based on the collected data, the volume of registered users collectively, and/or through the frequency of use by the registered users with the system. The collected data can further be used to select advertisements to be included in the media files and to determine eligibility for rewards.

### Implementation of the Systems and Methods Disclosed Herein

Various systems for encouraging complete playback of media files in the manners described above can be provided. In some embodiments, these systems may be implemented or performed, at least in part, by software stored on one or more tangible computer-readable media (e.g., one or more optical media discs, volatile memory or storage components (such as DRAM or SRAM), or nonvolatile memory or storage components (such as hard drives)) and executed on one or more computing systems. The computing systems can include one or more central processing units (CPUs) and a memory, such as random access memory (RAM) for temporary storage of information and/or a read only memory (ROM) for permanent storage of information, and a mass storage device, such as a hard drive, diskette, or optical media storage device. Typically, the modules of the computing system are connected to the computer using a standards-based bus system, such as, for example, Peripheral Component Interconnect (PCI), Microchannel, SCSI, Industrial Standard Architecture (ISA) and Extended ISA (EISA) architectures. The computing system may also include one or more commonly available input/output (I/O) devices and interfaces, such as a keyboard, a mouse, and/or a touchpad. In one embodiment, the I/O devices and interfaces include one or more display devices, such as a monitor, that allows the visual presentation of data to a user. More particularly, a display device provides for the presentation of Graphical User Interfaces (GUIs), application software data, and multimedia presentations, for example. The computing system may also provide a communications interface to various external devices.

Such software can be executed on a single computer or on a networked computer (e.g., via the Internet, a wide-area network, a local-area network, a client-server network, or other such network). The systems and methods disclosed herein can also be performed using cloud computing, a form of Internet-based computing, whereby shared resources, software and information are provided to computers and other devices on-demand. The software embodiments disclosed herein can be described in the general context of computer-executable instructions, such as those included in program modules, which can be executed in a computing environment on a target real or virtual processor. The computing system may run on a variety of computing devices, such as, for example, a server, a Windows server, a Structure Query Language server, a Unix server, a personal computer, a mainframe computer, a laptop computer, a cell phone, a personal digital assistant, a kiosk, an audio player, and so forth. The computing system is generally controlled and coordinated by operating system software. Conventional operating systems control and schedule computer processes for execution, perform memory management, provide file system, networking, and I/O services, and provide a user interface, such as a graphical user interface, among other things.

Furthermore, any of the software embodiments (comprising, for example, computer-executable instructions for causing a computer to perform any of the disclosed methods) can be transmitted, received, or accessed through a suitable communication means. Similarly, any data structure, data file, intermediate result, or final result created or modified using any of the disclosed methods can be transmitted, received, or accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means now known or unknown. Moreover, any data structure, data file, intermediate result, or final result produced by any of the disclosed methods can be displayed to a user using a suitable display device (e.g., a computer monitor or display). Such displaying can be performed as part of a computer-implemented method of performing any of the disclosed methods.

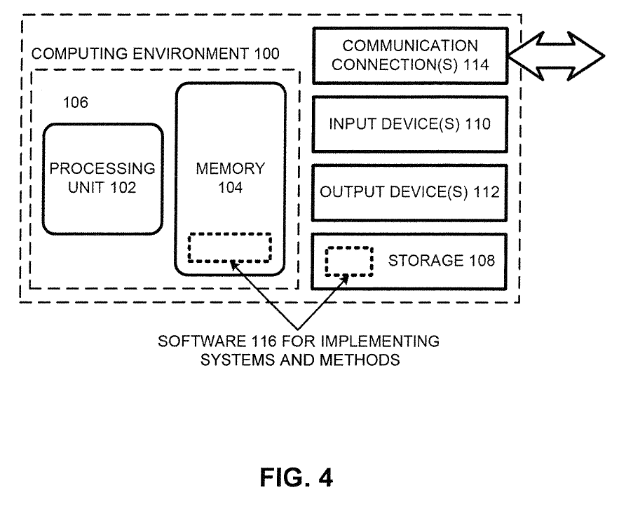

FIG. 4 illustrates a generalized example of a suitable computing environment 100 in which the described embodiments of systems and methods can be implemented. The computing environment 100 is not intended to suggest any limitation as to scope of use or functionality, as the methods described herein can be implemented in diverse general-purpose or special-purpose computing environments.

With reference to FIG. 4, the computing environment 100 includes at least one processing unit 102 and memory 104. In FIG. 4, this most basic configuration 106 is included within a dashed line. The processing unit 102 executes computer-executable instructions and may be a real or a virtual processor. In a multi-processing system, multiple processing units execute computer-executable instructions to increase processing power. The memory 104 may be volatile memory (e.g., registers, cache, RAM), non-volatile memory (e.g., ROM, EEPROM, flash memory, etc.), or some combination of the two. The memory 104 stores software 116 implementing one or more of the systems described herein.

The computing environment may have additional features. For example, the computing environment 100 includes storage 108, one or more input devices 110, one or more output devices 112, and one or more communication connections 114. An interconnection mechanism (not shown) such as a bus, controller, or network interconnects the components of the computing environment 100. Typically, operating system software (not shown) provides an operating environment for other software executing in the computing environment 100, and coordinates activities of the components of the computing environment 100.

The storage 108 may be removable or non-removable, and includes magnetic disks, magnetic tapes or cassettes, CD-ROMs, DVDs, or any other medium which can be used to store information and which can be accessed within the computing environment 100. The storage 108 can store instructions for the software 116 implementing any of the described systems and methods.

The input device(s) 110 can be a touch input device such as a keyboard, mouse, pen, or trackball, a voice input device, a scanning device, or another device that provides input to the computing environment 100. For audio or video encoding, the input device(s) 110 can be a sound card, video card, TV tuner card, or similar device that accepts audio or video input in analog or digital form, or a CD-ROM or CD-RW that reads audio or video samples into the computing environment 100. The output device(s) 112 can be a display or another device that provides output from the computing environment 100 to view the selected media content.

The communication connection(s) 114 enable communication over a communication medium to another computing entity. The communication medium is not a storage medium but conveys information such as computer-executable instructions, resource and construction project information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The various methods disclosed herein can be described in the general context of computer-readable media. Computer-readable media are any available media that can be accessed within or by a computing environment. By way of example, and not limitation, with the computing environment 100, computer-readable media include tangible computer-readable storage media such as memory 104 and storage 108.

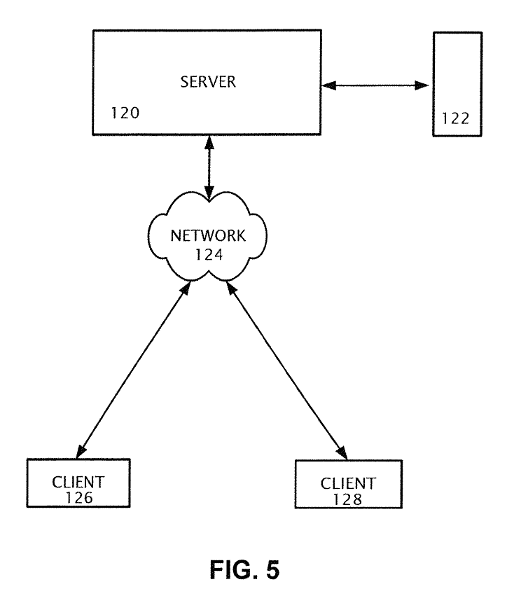

Any of the aspects of the technology described herein can also be performed using a distributed computer network. FIG. 5 shows a simplified embodiment of one such exemplary network. A server computer 120 can have an associated storage device 122 (internal or external to the server computer). For example, the server computer 120 can be configured to perform the calculations and analysis of information according to any of the disclosed embodiments. The server computer 120 can be coupled to a network, shown generally at 124, which can comprise, for example, a wide-area network, a local-area network, a client-server network, the Internet, or other such network. One or more client computers, such as those shown at 126, 128, may be coupled to the network 124 using a network protocol. The work may also be performed on a single, dedicated workstation, which has its own memory and one or more CPUs.

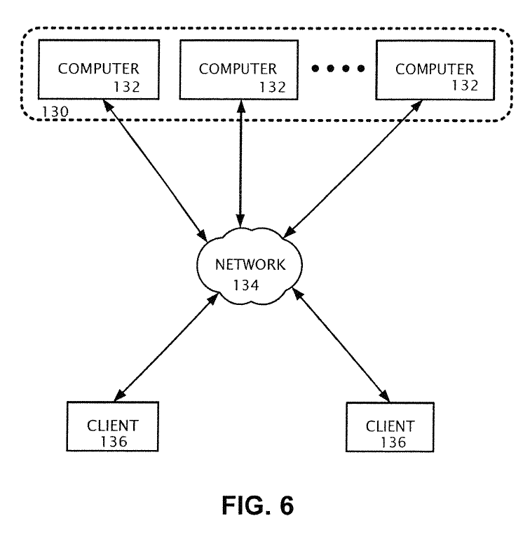

FIG. 6 shows another exemplary network, such as a network which can send and receive information and media content to the computing devices 26, 28, 30. One or more computers 132 communicate via a network 134 and form a computing environment 130 (e.g., a distributed computing environment). Each of the computers 132 in the computing environment 130 can be used to perform at least a portion of the calculation techniques according to any of the disclosed embodiments. The network 134 in the illustrated embodiment is also coupled to one or more client computers 136.

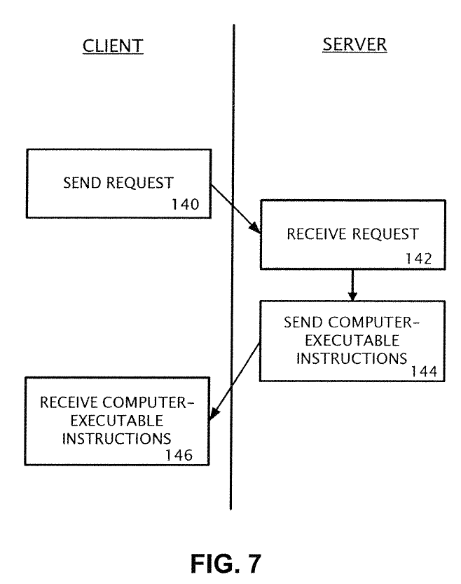

FIG. 7 shows one exemplary manner in which computer-executable instructions for performing any of the disclosed embodiments can be transmitted, accessed, or received using a remote server computer (such as the server computer 120 shown in FIG. 5) or a remote computing environment (such as the computing environment 130 shown in FIG. 6). At process block 140, for example, the client computer sends a request to download computer-executable instructions for performing any of the disclosed methods or techniques (e.g., after registering or logging in to the system). In process block 142, the request is received by the remote server or by respective components of the remote computing environment. In process block 144, the remote server or computing environment transmits computer-executable instructions for performing any of the disclosed methods or techniques. At 146, the computer-executable instructions are received (e.g., stored, buffered, and/or executed) by the client computer.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope of these claims.

We claim:

1. A method comprising:
receiving registration information from a user;
providing a media player to the user;
providing a media file to the user, the media file being configured to require the media player to be played;
receiving an indication that the user played the entire media file using the media player;
determining that the user is eligible for a reward based on the indication that the user played the entire media file.

2. The method of claim 1, wherein the registration information comprises demographic information about the user, and wherein the reward is based at least in part on the demographic information.

3. The method of claim 1, wherein the media file comprises at least one trigger portion configured to indicate to the media player that the media file has been played through the trigger portion.

4. The method of claim 1, wherein the media file comprises at least one notification portion configured to notify the user of the reward.

5. The method of claim 1, wherein the media player is configured to determine that the media file has been played entirely without user-caused interruption.

6. The method of claim 1, further comprising selecting one or more advertisements based on the registration information and inserting the selected advertisements into the media file prior to providing the media file to the user.

7. The method of claim 1, wherein determining that the user is eligible for a reward comprises determining that the media file was played by the user within a predetermined time range.

8. The method of claim 1, wherein determining that the user is eligible for a reward comprises determining that media file was played by the user in a predetermined location.

9. The method of claim 1, wherein the reward comprises an entry into a contest.

10. The method of claim 1, wherein the reward comprises points that can be redeemed for a prize.

11. The method of claim 1, wherein the media file is a music album.

12. A method comprises:
receiving registration information from a user;
providing a media player to the user;
receiving a selection of a desired media file from a user;
selecting at least one advertisement targeted to the user based on the registration information;
inserting the advertisement into the media file;
providing the media file to the user, the media file being configured to require the media player for playback by the user;
determining, with the media player, that the media file has been played entirely by the user; and
notifying the user of a reward for playing the media file entirely.

13. The method of claim 12, wherein determining that the media file has been played entirely comprises determining that the media file has not be fast-forwarded and that the media filed has been played from a beginning to an end without interruption.

14. The method of claim 12, wherein the media file comprises a trigger portion and determining that the media file has been played entirely comprises determining the trigger portion has been played without interruption.

15. The method of claim 12, wherein notifying the user of a reward is contingent on a determination that the media file was played during a certain time range.

16. The method of claim 12, wherein notifying the user of a reward is contingent on the user having a predetermined demographic attribute.

17. The method of claim 12, further comprising determining that the media file has been played on the provided media player.

18. The method of claim 12, wherein the media player is configured to track who the user is and the time when the media file is played.

19. The method of claim 12, wherein the media player is configured to receive the selection of a desired media file from the user, select and insert the advertisements based on information about the user, and notify the user of the reward.

20. The method of claim 12, wherein the media file comprises an audio album comprising plural audio tracks, and wherein determining that the media file has been played entirely comprises determining that each of the audio tracks has been played in sequential order without fast-forwarding.
